(19) United States
(12) Patent Application Publication
(10) Pub. No.: US 2007/0206347 A1
(43) Pub. Date: Sep. 6, 2007

(54) PORTABLE NOTEBOOK COMPUTER

(75) Inventor: SZU-WEI KUO, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/608,798

(22) Filed: Dec. 9, 2006

(30) Foreign Application Priority Data
Mar. 2, 2006 (CN) 200620055916.8

(51) Int. Cl. G06F 1/16

(52) U.S. Cl. 361/683

(57) ABSTRACT

A portable notebook computer includes a base, and a display pivotably connected to the base. An I/O port is provided on a top surface of the base configured to connect the portable notebook computer to external electronic devices.

### BACKGROUND OF THE INVENTION

1. Field of the Invention

The present invention relates to portable notebook computers.

2. Description of Related Art

Personal computers can be classified into desktop computers, portable notebook computers, and etc. The desktop computers are easy to upgrade but inconvenient in carrying from place to place. Portable notebook computers however, are thin and lightweight. Therefore, portable notebook computers are very popular since they provide considerable convenience. The convenience and transportability of portable notebook computers has created a large and lucrative market for manufacturers of such machines. Generally, a portable notebook computer includes a plurality of I/O ports to extend its function. The ports are usually set in edges of the portable notebook computer. To meet user's needs, portable notebook computers have become thinner and thinner. Adding more I/O ports to the edges of portable notebook computers has become more difficult because portable notebook computers are now so thin.

In addition, the surface portion of the portable notebook computer for supporting the user's wrists is just a flat hard surface, so the wrists will feel uncomfortable if the user uses the portable notebook computer for a long time.

What is needed, therefore, is a more comfortable portable notebook computer having more I/O ports provided therein.

### SUMMARY OF THE INVENTION

In one preferred embodiment, a portable notebook computer includes a base, and a display pivotably connected to the base. An I/O port is provided on a top surface of the base configured to connect the portable notebook computer to external electronic devices.

Other advantages and novel features will become more apparent from the following detailed description of preferred embodiments when taken in conjunction with the accompanying drawings, in which:

### BRIEF DESCRIPTION OF THE DRAWINGS

FIG. 1 is an exploded, isometric view of a portable notebook computer in accordance with a first preferred embodiment of the present invention;

FIG. 2 is an assembled view of FIG. 1;

FIG. 3 is an isometric view of a portable notebook computer in accordance with a second preferred embodiment of the present invention;

FIG. 4 is an isometric view of a portable notebook computer in accordance with a third preferred embodiment of the present invention; and

FIG. 5 is an isometric view of a portable notebook computer in accordance with a fourth preferred embodiment of the present invention.

### DETAILED DESCRIPTION OF THE INVENTION

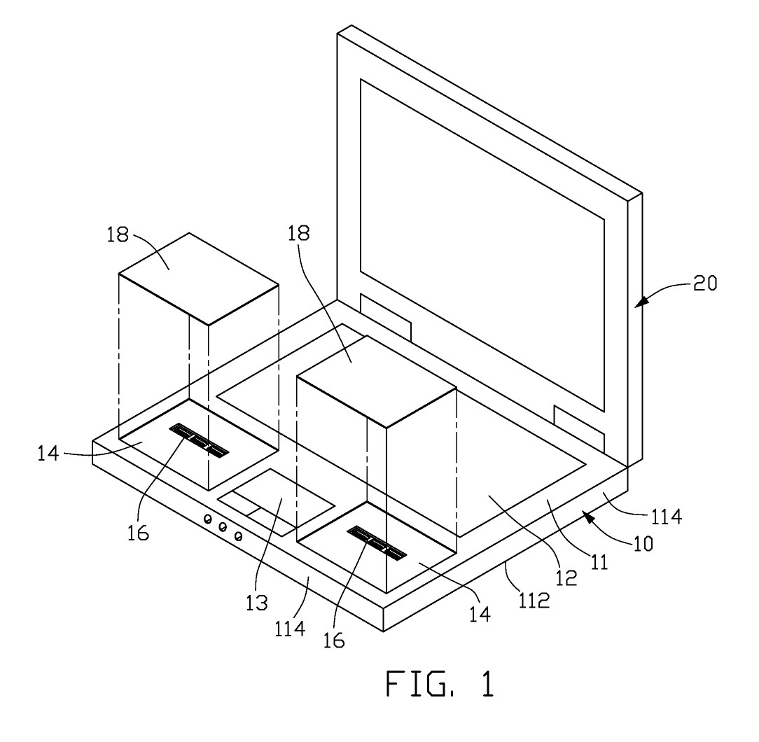

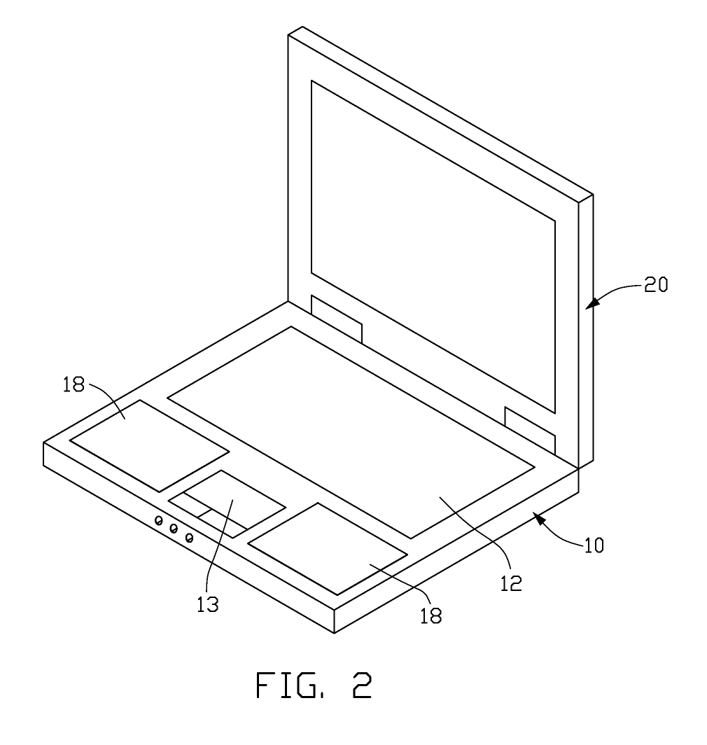

Referring to FIG. 1 and FIG. 2, in a first preferred embodiment of the invention, a portable notebook computer includes a base 10, and a display 20 pivotably connected to the base 10. The base 10 includes a top surface 11, a bottom surface 112, and a plurality of lateral surfaces 114 connected between the top and the bottom surfaces 11, 112. The top surface 11 includes a pivot end connecting with the display 20 and a free end opposing to the pivot end. An input device, such as a keyboard 12, is set on the top surface 11 of the base 10 near the pivot end for inputting information into the portable notebook computer. A touchpad 13 is set on the top surface 111 of the base 10 near the free end. Two rectangular notches 14 are defined in the top surface 11 of the base 10 near the free end. The touchpad 13 is between the notches 14. Three I/O ports are set in each notch 14 and are electrically connected to a motherboard (not shown) installed within the base 10. In this first preferred embodiment of the invention, the I/O ports are USB ports 16. Two covers 18 are provided for covering the notches 14 respectively for blocking off dust.

In use, the covers 18 are detached from the base 10 to expose the USB ports 16. The USB ports 16 are used for connecting plugs of external devices, such as digital cameras.

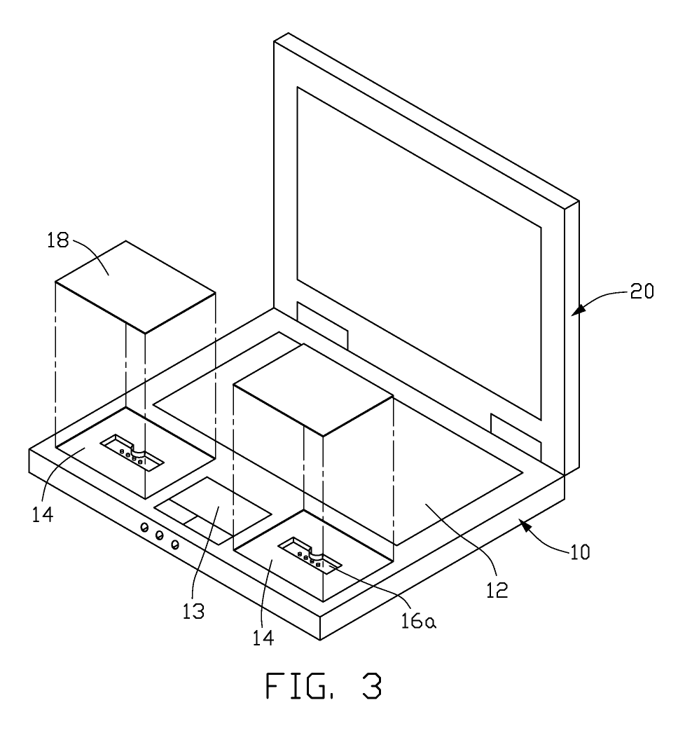

Referring to FIG. 3, in a second preferred embodiment of the invention, the I/O ports may be two IEEE1394 ports 16a or other type I/O ports.

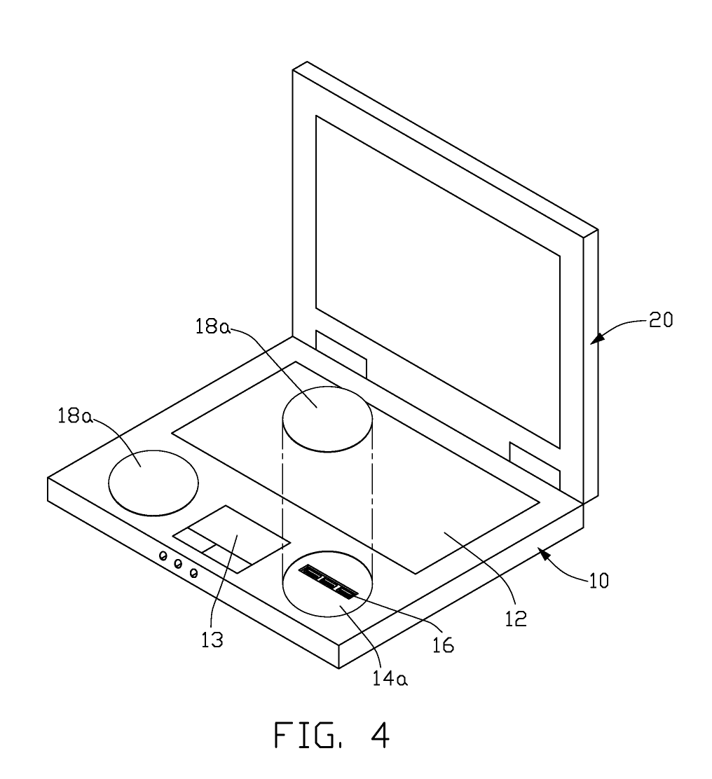

Referring to FIG. 4, in a third preferred embodiment of the invention, two notches 14a and two corresponding covers 18a are all rounded.

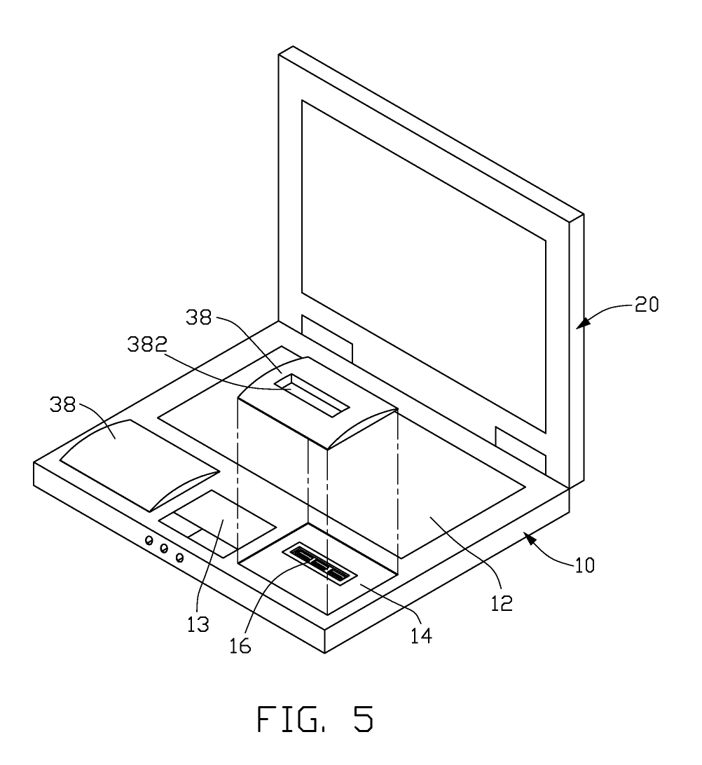

Referring to FIG. 5, in a fourth preferred embodiment of the invention, two covers 38 are made from soft material, such as rubber. Each cover 38 has a convex portion at the middle thereof for supporting wrists of users. Thus the wrists of the user will not feel uncomfortable even if the user uses the portable notebook computer for a long time. One of the covers 38 has a slot 382 defined therein for exposing the I/O ports 16.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A portable notebook computer comprising:
a base, an I/O port provided on a top surface of the base; and
a display pivotably connected to the base, wherein the top surface of the base faces to the display when the display is closed to the base.

2. The portable notebook computer as claimed in claim 1, wherein the base comprises a pivot end for pivotably connecting the display to the base, the top surface of the base defines a notch away from the pivot end, the I/O port is set in the notch.

3. The portable notebook computer as claimed in claim 2, wherein a cover is provided for covering the notch.

4. The portable notebook computer as claimed in claim 3, wherein the notch and the cover are both rounded.

5. The portable notebook computer as claimed in claim 3, wherein the notch and the cover are both rectangular.

6. The portable notebook computer as claimed in claim 3, wherein the cover has a convex portion at the middle thereof.

7. The portable notebook computer as claimed in claim 1, wherein the I/O port is a USB port.

8. The portable notebook computer as claimed in claim 1, wherein the I/O port is an IEEE1394 port.

9. A portable notebook computer comprising:
a base comprising a top surface, a bottom surface, and a plurality of lateral surfaces connected between the top and the bottom surfaces;
an input device disposed on the top surface of the base for facilitating inputting information into the portable notebook computer; and
an I/O port arranged on the top surface of the base other than the lateral surfaces for facilitating connecting the portable notebook computer to external devices.

10. The portable notebook computer as claimed in claim 9, wherein a cover is provided to cover the I/O port when not in use.

11. The portable notebook computer as claimed in claim 10, wherein the cover comprises a convex portion at a middle thereof for supporting wrists of a user.

12. The portable notebook computer as claimed in claim 9, wherein the I/O port is a USB port.

13. The portable notebook computer as claimed in claim 9, wherein I/O port is an IEEE1394 port.

14. A portable notebook computer comprising:
a base comprising a top surface with a pivot end and a free end opposing to the pivot end;
a display pivotably connected to the pivot end of the base;
an input device disposed on the top surface adjacent to the pivot end for facilitating inputting information into the computer;
a touchpad disposed on the top surface adjacent to the free end;
at least one depressed portion sunk from one portion of the top surface adjacent to the free end;
at least one I/O port disposed in the at least one depressed portion for electrically connecting the computer to external electronic devices; and
at least one cover attached to the top surface of the base to cover the depressed portion.

15. The portable notebook computer as claimed in claim 14, comprising a pair of depressed portions and a pair of I/O ports disposed in the depressed portions respectively, a touchpad being disposed between the I/O ports.

16. The portable notebook computer as claimed in claim 14, wherein the at least one cover is made of a soft material different from a material of which the top surface is made.

17. The portable notebook computer as claimed in claim 16, wherein the at least one cover is made of rubber.

18. The portable notebook computer as claimed in claim 14, wherein the at least one cover is detachably attached to the base such that the at least one cover is removable from the base when the at least one I/O port is in use.

19. The portable notebook computer as claimed in claim 14, wherein the at least one cover defines an opening for exposing the at least one I/O port.
